(19) United States
(12) Patent Application Publication
(10) Pub. No.: US 2010/0311882 A1
(43) Pub. Date: Dec. 9, 2010

(54) THERMALLY CONDUCTIVE POLYAMIDES

(75) Inventors: Peter Eibeck, Ludwigshafen (DE); Jochen Engelmann, Neustadt (DE); Ralf Neuhaus, Heidelberg (DE); Uske Klaus, Bad Durkheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/295,100

(22) PCT Filed: Mar. 22, 2007
(86) PCT No.: PCT/EP2007/052728

§ 371 Date: Aug. 19, 2010

(30) Foreign Application Priority Data
Mar. 29, 2006 (EP) 06111931.9

(51) Int. Cl. C08K 5/18

(52) U.S. Cl. 524/240

(57) ABSTRACT

Thermoplastic molding compisitions, comprising
A) from 19.9% to 59.9% by weight of thermoplastic polyamide
B) from 40 to 80% by weight of an aluminum oxide or magnesium oxide or a mixture of these
C) from 0.1 to 2% by weight of nigrosin
D) from 0 to 20% by weight of other additives,
   where the total of the percentages by weight of A) to D) is 100%.

The invention relates to thermoplastic molding compositions, comprising
A) from 19.9 to 59.9% by weight of a thermoplastic polyamide
B) from 40 to 80% by weight of an aluminum oxide or magnesium oxide or a mixture of these
C) from 0.1 to 2% by weight of nigrosin
D) from 0 to 20% by weight of other additives,

where the total of the percentages by weight of A) to D) is 100%.

The invention further relates to the use of the inventive molding compositions for production of fibers, foils, or moldings of any type, and also to the moldings thus obtainable.

Addition of nigrosin to heat-stabilized, reinforced PA compositions is known by way of example from EP-A 813 568. PA compositions which comprise MgO or comprise Al oxide are known from JP-A 63/270 761.

It is known that the thermal conductivity (TC) of polymers can be increased via addition of mineral or metallic fillers. In order to achieve significant effects, addition of large amounts of filler is necessary, and this has a disadvantageous effect on the processibility of the composites and on the mechanical properties and the surface quality of the moldings obtainable therefrom.

An object underlying the present invention was therefore to provide molding compositions which have good processibility and which can be processed to give moldings with increased thermal conductivity and with good mechanical properties (in particular toughness).

Accordingly, the molding compositions defined at the outset have been found. The subclaims give preferred embodiments.

The inventive molding compositions comprise, as component A), from 19.9 to 59.9% by weight, preferably from 20 to 49.8% by weight, and in particular from 27 to 49% by weight, of at least one polyamide.

The viscosity number of the polyamides of the inventive molding compositions is generally from 70 to 350 ml/g, preferably from 70 to 170 ml/g, determined on a 0.5% strength by weight solution in 96% strength by weight sulfuric acid at 25° C. to ISO 307.

Preference is given to semicrystalline or amorphous resin whose molecular weight (weight-average) is at least 5000, for example those described in the U.S. Pat. Nos. 2,071,250, 2,071,251, 2,130,523, 2,130,948, 2,241,322, 2,312,966, 2,512,606, and 3,393,210.

Examples of these are polyamides which derive from lactams having from 7 to 13 ring members, e.g. polycaprolactam, polycaprylolactam and polylaurolactam, and also polyamides obtained via reaction of dicarboxylic acids with diamines.

Dicarboxylic acids which may be used are alkanedicarboxylic acids having from 6 to 12, in particular from 6 to 10, carbon atoms, and aromatic dicarboxylic acids. Acids which may be mentioned here merely as examples are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine, di(4-aminophenyl)methane, di(4-aminocyclohexyl)methane, 2,2-di(4-aminophenyl)propane, 2,2-di(4-amino-cyclohexyl)propane or 1,5-diamino-2-methylpentane.

Preferred polyamides are polyhexamethyleneadipamide, polyhexamethylene-sebacamide and polycaprolactam, and also nylon-6/6,6 copolyamides, in particular having a proportion of from 5 to 95% by weight of caprolactam units.

Other suitable polyamides are obtainable from ω-aminoalkyl nitriles, e.g. amino-capronitrile (PA 6) and adipodinitrile with hexamethylenediamine (PA 66) via what is known as direct polymerization in the presence of water, for example as described in DE-A 10313681, EP-A 1198491 and EP 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio.

Other polyamides which have proven particularly advantageous are semiaromatic copolyamides, such as PA 6/6T and PA 66/6T, where the triamine content of these is less than 0.5% by weight, preferably less than 0.3% by weight (see EP-A 299 444).

The processes described in EP-A 129 195 and 129 196 can be used to prepare the preferred semiaromatic copolyamides with low triamine content.

The following list, which is not comprehensive, comprises the polyamides A) mentioned and other polyamides A) for the purposes of the invention, and the monomers present:

AB Polymers:

PA 4 Pyrrolidone

PA 6 ε-Caprolactam

PA 7 Ethanolactam

PA 8 Caprylolactam

PA 9 9-Aminopelargonic acid

PA 11 11-Aminoundecanoic acid

PA 12 Laurolactam

AA/BB Polymers:

PA 46 Tetramethylenediamine, adipic acid

PA 66 Hexamethylenediamine, adipic acid

PA 69 Hexamethylenediamine, azelaic acid

PA 610 Hexamethylenediamine, sebacic acid

PA 612 Hexamethylenediamine, decanedicarboxylic acid

PA 613 Hexamethylenediamine, undecanedicarboxylic acid

PA 1212 1,12-Dodecanediamine, decanedicarboxylic acid

PA 1313 1,13-Diaminotridecane, undecanedicarboxylic acid

PA 6T Hexamethylenediamine, terephthalic acid

PA MXD6 m-Xylylenediamine, adipic acid

AA/BB Polymers:

PA 6I Hexamethylenediamine, isophthalic acid

PA 6-3-T Trimethylhexamethylenediamine, terephthalic acid

PA 6/6T (see PA 6 and PA 6T)

PA 6/66 (see PA 6 and PA 66)

PA 6/12 (see PA 6 and PA 12)

PA 66/6/610 (see PA 66, PA 6 and PA 610)

PA 6I/6T (see PA 6I and PA 6T)

PA PACM 12 Diaminodicyclohexylmethane, laurolactam

PA 6I/6T/PACM as PA 6I/6T+diaminodicyclohexylmethane

PA 12/MACMI Laurolactam, dimethyldiaminodicyclohexylmethane, isophthalic acid

PA 12/MACMT Laurolactam, dimethyldiaminodicyclohexylmethane, terephthalic acid

PA PDA-T Phenylenediamine, terephthalic acid

According to the invention, the thermoplastic molding compositions comprise, as component B), from 40 to 80% by weight of an Al oxide or Mg oxide, or a mixture of these. The proportion of B) in the inventive molding compositions is preferably from 50 to 70% by weight and in particular from 50 to 60% by weight.

The aspect ratio of suitable oxides is preferably smaller than 10, preferably smaller than 7.5, and in particular smaller than 5.

The BET surface area to DIN 66131 of preferred oxides is smaller than or equal to 14 m²/g, preferably smaller than or equal to 10 m²/g.

The preferred average particle diameter (d₅₀) is from 0.2 to 20 μm, preferably from 0.3 to 15 μm, and in particular from 0.35 to 10 μm, according to laser granulometry to ISO 13320 EN.

Products of this type are commercially obtainable by way of example from Almatis.

The inventive molding compositions comprise, as component C), from 0.1 to 2% by weight, preferably from 0.2 to 1.5% by weight, and in particular from 0.25 to 1% by weight, of a nigrosin.

Nigrosins are generally a group of black or gray phenazine dyes (azine dyes) related to the indulines and taking various forms (water-soluble, oleosoluble, spirit-soluble), used in wool dyeing and wool printing, in black dyeing of silks, and in the coloring of leather, of shoe creams, of varnishes, of plastics, of stoving lacquers, of inks, and the like, and also as microscopy dyes.

Nigrosins are obtained industrially via heating of nitrobenzene, aniline, and aniline hydrochloride with metallic iron and FeCl₃ (the name being derived from the Latin niger=black).

Component C) can be used in the form of free base or else in the form of salt (e.g. hydrochloride).

Further details concerning nigrosins can be found by way of example in the electronic encyclopedia Rompp Online, Version 2.8, Thieme-Verlag Stuttgart, 2006, keyword “Nigrosin”.

The inventive molding compositions can comprise, as components D), from 0 to 20% by weight, preferably up to 10% by weight, of other additives.

The inventive molding compositions can comprise, as component D), from 0 to 3% by weight, preferably from 0.05 to 3% by weight, with preference from 0.1 to 1.5% by weight, and in particular from 0.1 to 1% by weight, of a lubricant.

Preference is given to the Al, alkali metal, or alkaline earth metal salts, or esters or amides of fatty acids having from 10 to 44 carbon atoms, preferably having from 14 to 44 carbon atoms.

The metal ions are preferably alkaline earth metal and Al, particular preference being given to Ca or Mg.

Preferred metal salts are Ca stearate and Ca montanate, and also Al stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol or n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The inventive molding compositions can comprise, as other components D), heat stabilizers or antioxidants, or a mixture of these, selected from the group of the copper compounds, sterically hindered phenols, sterically hindered aliphatic amines, and/or aromatic amines.

The inventive molding compositions can comprise from 0.05 to 3% by weight, preferably from 0.1 to 1.5% by weight, and in particular from 0.1 to 1% by weight, of copper compounds, preferably in the form of Cu(I) halide, in particular in a mixture with an alkali metal halide, preferably KI, in particular in the ratio 1:4, or of a sterically hindered phenol or of an amine stabilizer, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if the concentrate comprising the polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogenous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

Suitable polyamides for the concentrate are homopolyamides and copolyamides, in particular nylon-6 and nylon-6,6.

Suitable sterically hindered phenols are in principle any of the compounds having a phenolic structure and having at least one bulky group on the phenolic ring.

By way of example, compounds of the formula

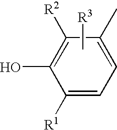

can be used, in which:

R¹ and R² are an alkyl group, a substituted alkyl group, or a substituted triazole group, where the radicals R¹ and R² can be identical or different, and R³ is an alkyl group, a substituted alkyl group, an alkoxy group, or a substituted amino group.

Antioxidants of the type mentioned are described by way of example in DE-A 27 02 661 (U.S. Pat. No. 4,360,617).

Another group of preferred sterically hindered phenols is those derived from substituted benzenecarboxylic acids, in particular from substituted benzenepropionic acids.

Particularly preferred compounds from this class are compounds of the formula

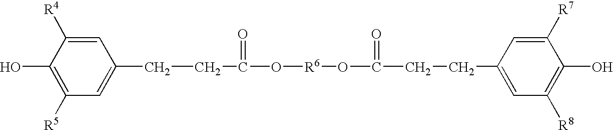

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to this formula are

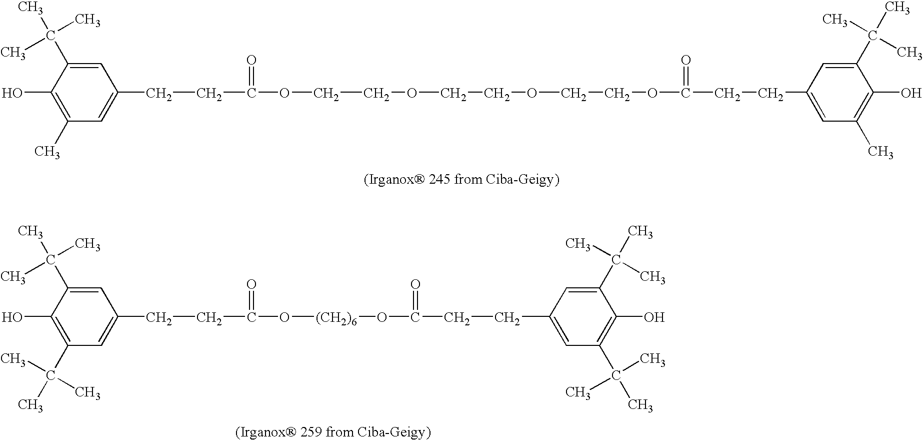

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxy-phenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydro-cinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxy-benzyl)benzene, 4,4′-methylenebis(2,6-di-tert-butylphenol), 3,5-di-tert-butyl-4-hydroxy-benzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl]propionate (Irganox® 259), pentaerythrityl tetrakis[3-(3,5-di-tert-butyl-4-hydroxyphenyl)propionate], and also N,N′-hexamethylene-bis-3,5-di-tert-butyl-4-hydroxyhydrocinnamide (Irganox® 1098), and the product Irganox® 245 described above from Ciba Geigy, which has particularly good suitability.

The material comprises amounts of from 0.05 to 3% by weight, preferably from 0.1 to 1.5% by weight, in particular from 0.1 to 1% by weight, based on the total weight of the molding compositions A) to E), of the phenolic antioxidants, which may be used individually or in the form of a mixture.

In some instances, sterically hindered phenols having not more than one sterically hindered group in ortho-position with respect to the phenolic hydroxy group have proven particularly advantageous; in particular when assessing colorfastness on storage in diffuse light over prolonged periods.

The inventive molding compositions can comprise from 0 to 3% by weight, preferably from 0.01 to 2% by weight, of the aminic stabilizers, with preference from 0.05 to 1.5% by weight of an amine stabilizer. Sterically hindered amine compounds have preferred suitability. Examples of compounds that can be used are those of the formula

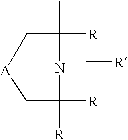

where

R are identical or different alkyl radicals,

R′ is hydrogen or an alkyl radical, and

A is an optionally substituted 2- or 3-membered alkylene chain.

Preferred components are derivatives of 2,2,6,6-tetramethylpiperidine, such as:

4-acetoxy-2,2,6,6-tetramethylpiperidine,

4-stearoyloxy-2,2,6,6-tetramethylpiperidine,

4-aryloyloxy-2,2,6,6-tetramethylpiperidine,

4-methoxy-2,2,6,6-tetramethylpiperidine,

4-benzoyloxy-2,2,6,6-tetramethylpiperidine,

4-cyclohexyloxy-2,2,6,6-tetramethylpiperidine,

4-phenoxy-2,2,6,6-tetramethylpiperidine,

4-benzoxy-2,2,6,6-tetramethylpiperidine,

4-(phenylcarbamoyloxy)-2,2,6,6-tetramethylpiperidine.

Other suitable compounds are

bis(2,2,6,6-tetramethyl-4-piperidyl)oxalate,

bis(2,2,6,6-tetramethyl-4-piperidyl)malonate,

bis(2,2,6,6-tetramethyl-4-piperidyl)adipate,

bis(1,2,2,6,6-pentamethylpiperidyl)sebacate,

bis(2,2,6,6-tetramethyl-4-piperidyl)terephthalate,

1,2-bis(2,2,6,6-tetramethyl-4-piperidyloxy)ethane,

bis(2,2,6,6-tetramethyl-4-piperidyl)hexamethylene 1,6-dicarbamate,

bis(1-methyl-2,2,6,6-tetramethyl-4-dipiperidyl)adipate, and

tris(2,2,6,6-tetramethyl-4-piperidyl)benzene-1,3,5-tricarboxylate.

Other compounds with particularly good suitability are moreover relatively high-molecular-weight piperidine derivatives, such as the dimethyl succinate polymer with 4-hydroxy-2,2,6,6-tetramethyl-7-piperidinylethanol, or poly-6-(1,1,3,3-tetramethyl-butypamino-1,3,5-triazine-2,4-diyl(2,2,6,6-tetramethyl-4-piperidinyl)imino-1,6-hexane-diyl(2,2,6,6-tetramethyl-14-piperidinyl)imino, these having particularly good suitability, as also has bis(2,2,6,6-tetramethyl-4-piperidyl)sebacate.

Compounds of this type are commercially available with the name Tinuvin® or Chimasorb® (registered trademark of Ciba Spezialitatenchemie GmbH).

Another particularly preferred amine compound that may be mentioned is Uvinul® 4049 H from BASF AG:

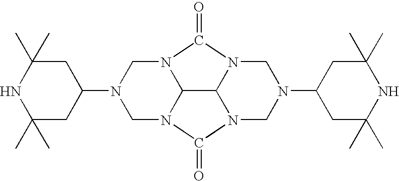

Other particularly preferred examples of stabilizers that can be used according to the invention are those based on secondary aromatic amines, e.g. adducts derived from phenylenediamine with acetone (Naugard® A), adducts derived from phenylene-diamine with linolene, Naugard® 445 (II), N,N′-dinaphthyl-p-phenylenediamine (III), N-phenyl-N′-cyclohexyl-p-phenylenediamine (IV), or a mixture of two or more of these

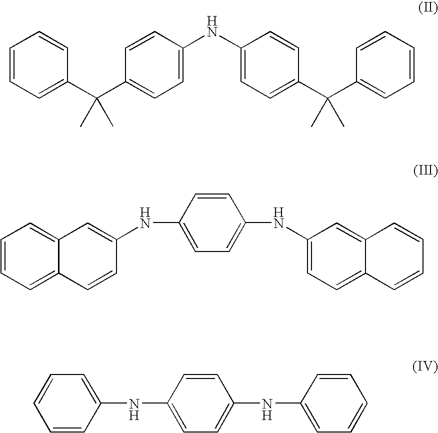

Other conventional additives D), by way of example, are amounts of up to 10% by weight, preferably from 1 to 5% by weight, of elastomeric polymers (also often termed impact modifiers, elastomers, or rubbers).

These are very generally copolymers which have preferably been built up from at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenyl-norbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these are acrylic acid, methacrylic acid and derivatives thereof, e.g. glycidyl(meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups and having the general formulae I, II, III or IV

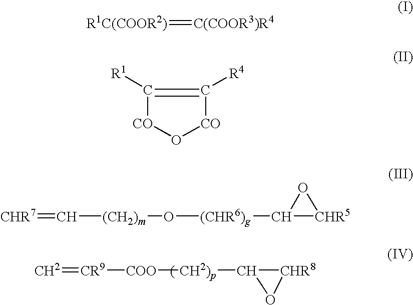

where R¹ to R⁹ are hydrogen or alkyl groups having from 1 to 6 carbon atoms, and m is a whole number from 0 to 20, g is a whole number from 0 to 10 and p is a whole number from 0 to 5.

R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

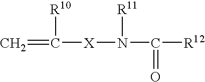

where the substituents can be defined as follows:
R¹⁰ is hydrogen or a C₁-C₄-alkyl group,
R¹¹ is hydrogen, a C₁-C₈-alkyl group or an aryl group, in particular phenyl,
R¹² is hydrogen, a C₁-C₁₀-alkyl group, a C₆-C₁₂-aryl group, or —OR¹³,
R¹³ is a C₁-C₈-alkyl group or a C₆-C₁₂-aryl group, which can optionally have substitution by groups that comprise O or by groups that comprise N,
X is a chemical bond, a C₁-C₁₀-alkylene group, or a C₆-C₁₂-arylene group, or

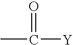

Y is O—Z or NH—Z, and
Z is a C₁-C₁₀-alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, | styrene, acrylonitrile, methyl |
| | n-butyl acrylate, ethylhexyl | methacrylate |
| | acrylate, or a mixture of | |
| | these | |
| II | as I, but with concomitant | as I |
| | use of crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant use |
| | | of monomers having reactive |
| | | groups, as described herein |
| V | styrene, acrylonitrile, | first envelope composed of |
| | methyl methacrylate, or a | monomers as described under I |
| | mixture of these | and II for the core, second |
| | | envelope as described under I or IV |
| | | for the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 2.5 576, EP-A 235 690, DE-A 38 00 603 and. EP-A 319 290.

It is, of course, also possible to use mixtures of the types of rubber listed above.

Fibrous or particulate fillers D) which may be mentioned are carbon fibers, glass fibers, glass beads, amorphous silica, calcium silicate, calcium metasilicate, magnesium carbonate, kaolin, chalk, powdered quartz, mica, barium sulfate and feldspar, used in amounts of up to 20% by weight, in particular from 1 to 15% by weight.

Preferred fibrous fillers which may be mentioned are carbon fibers, aramid fibers and potassium titanate fibers, and particular preference is given to glass fibers in the form of E glass. These may be used as rovings or in the commercially available forms of chopped glass.

The fibrous fillers may have been surface-pretreated with a silane compound to improve compatibility with the thermoplastic.

Suitable silane compounds have the general formula:

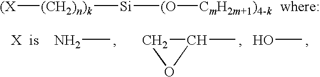

n is a whole number from 2 to 10, preferably 3 to 4,

m is a whole number from 1 to 5, preferably 1 to 2, and

k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight and in particular from 0.05 to 0.5% by weight (based on the fibrous filters).

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may, if appropriate, have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength.

The thermoplastic molding compositions of the invention may comprise, as components D), usual processing aids, such as stabilizers, oxidation retarders, agents to counteract decomposition due to heat and decomposition due to ultraviolet light, lubricants and mold-release agents, colorants, such as dyes and pigments, nucleating agents, plasticizers, flame retardants, etc.

Examples which may be mentioned of oxidation retarders and heat stabilizers are sterically hindered phenols and other amines (e.g. TAD), hydroquinones, various substituted members of these groups, and mixtures of these in concentrations of up to 1% by weight, based on the weight of the thermoplastic molding compositions.

UV stabilizers which may be mentioned, and are generally used in amounts of up to 2% by weight, based on the molding composition, are various substituted resorcinols, salicylates, benzotriazoles, and benzophenones.

Colorants which may be added are inorganic pigments, such as titanium dioxide, ultramarine blue, iron oxide, and carbon black and/or graphite, and also organic pigments, such as phthalocyanines, quinacridones and perylenes, and also dyes, such as nigrosin and anthraquinones.

Nucleating agents which may be used are sodium phenylphosphinate, alumina, silica, and preferably talc.

The inventive thermoplastic molding compositions may be prepared by methods known per se, by mixing the starting components in conventional mixing apparatus, such as screw extruders, Brabender mixers or Banbury mixers, and then extruding them. The extrudate may then be cooled and comminuted. It is also possible to premix individual components and then to add the remaining starting materials individually and/or likewise in a mixture. The mixing temperatures are generally from 230 to 320° C.

In another preferred procedure, components B) and C), and also, if appropriate, D) can be mixed with a prepolymer, compounded, and pelletized. The resultant pellets are then solid-phase condensed under an inert gas, continuously or batchwise, at a temperature below the melting point of component A) until the desired viscosity has been reached.

The inventive thermoplastic molding compositions feature good flowability together with good mechanical properties, and also markedly improved thermal conductivity.

They are suitable for production of fibers, of foils, or of moldings of any type. A few preferred examples are mentioned below:

The molding compositions described are suitable for improving dissipation of heat from heat sources.

The heat dissipated can be power loss from electrical modules or else heat intentionally generated via heating elements.

Among electrical modules with power loss are, for example, CPUs, resistors, ICs, batteries, accumulators, motors, coils, relays, diodes, conductor tracks, etc.

Dissipation of the heat demands maximum effectiveness of contact between heat source and molding composition so that heat can be discharged from the source by way of the molding composition to the environment (gaseous, liquid, solid). In order to improve the quality of contact, it is also possible to use substances known as thermally conductive pastes. The best heat-removal function is obtained when the molding compositions are injected around the heat source.

The molding compositions are also suitable for production of heat exchangers. It is usually a relatively hot medium (gaseous, liquid) passing through heat exchangers and in this process discharging heat to a relatively cool medium (usually also gaseous or liquid) via a wall. Examples of these devices are heaters in homes or radiators in cars. With regard to the suitability of the molding compositions described for production of heat exchangers, no importance is attached to the direction in which heat is transported, and it is insignificant whether hot and/or cool medium is actively circulated or is subjected to free convection. However, the heat exchange between the media concerned is usually improved by active circulation, irrespective of the wall material used.

### EXAMPLES

The following components were used:

Component A/1:

Nylon-6,6 whose viscosity number VN was 125 ml/g, measured on a 0.5% strength by weight solution in 96% strength by weight sulfuric acid at 25° C. to ISO 307 (the material used being Ultramid® A24 from BASF AG).

Component A/2:

PA 66 whose VN was 75 ml/g (Ultramid® A15 from BASF AG)

Components B:
B/1 Aluminum oxide CL4400 FG: 99.8% Al₂O₃, BET surface area 0.6 m²/g, D50 5.6 μm
B/2 Aluminum oxide CT10 SG: 99.55% Al₂O₃, BET surface area 13 m²/g, D50 3 μm
B/3 Aluminum oxide A16 SG: 99.8% Al₂O₃, BET surface area 8.9 m²/g, D50 0.4 μm, D90 1.5 μm
B/4 Aluminum oxide P30: 99% Al₂O₃, BET surface area 13 m²/g, D50 10 μm

Component C:

Nigrosin Base BA (=C.I. Solvent Black 7), commercially available product from Lanxess

Component D/1:

CuI/KI (molar ratio 1:4)

Component D/2:

Flexamin: about 65% of condensate derived from diphenylamine and acetone/formaldehyde and about 35% of 4,4′-diphenyl-p-phenylenediarnine

Component D/3:

Exxelor® VA 1803 from Exxon Mobile Chemicals: ethylene-propylene copolymer (about 53% of propylene), modified with about 1% of maleic anhydride

Component D/4:

Carbon black masterbatch with 33% by weight of carbon black and 67% by weight of polyethylene

Component D/5:

Ca stearate

Component D/6:

Ethylenebisstearylamide.

The molding compositions were prepared in a ZSK 30 with 10 kg/h throughput and a flat temperature profile at about 280° C. Component B) was added at 2 feed points to the melt of A).

The following tests were carried out:

Tensile test to ISO 527,

Impact resistance (Charpy 11 U): ISO 179-1

VN: c=5 g/l in 96% strength sulfuric acid, to ISO 307

Flow spiral: BASF method: melt temperature 275° C., mold temperature 80° C.,

height of flow spiral 2 mm, injection pressure 1000 bar,

Thermal conductivity: laser flash method using LFA 447 equipment from Netzsch,

Surface quality:

Subjective assessment on viewing of injection-molded plaques (melt temperature 275° C., mold temperature 80° C.)

+: no/hardly any discernible exudation of filler

o: discernible exudation of filler

−: very noticeable exudation of filler

BET to DIN 66131

d₅₀/d₉₀ via laser granulometry to ISO 13320 EN.

The constitutions of the molding compositions and the results of the tests are given in the table.

TABLE

| Components | | | | | | | | | |
|---|---|---|---|---|---|---|---|---|---|
| [% by wt.] | IE1.1 | IE1.2 | IE1.3 | IE1.4 | CE1.1 | CE1.2 | CE1.3 | IE1.4 | IE2 |
| A/1 | 44 | 44 | 44.2 | 44.2 | 44.5 | 44.5 | 44.7 | 44.75 | 23.7 |
| A/2 | | | | | | | | | 20 |
| B/1 | 55 | | | | 55 | | | | 55 |
| B/2 | | 55 | | | | 55 | | | |
| B/3 | | | 55 | | | | 55 | | |
| B/4 | | | | 55 | | | | 55 | |
| C | 0.7 | 0.7 | 0.7 | 0.7 | | | | | 0.7 |
| D/1 | | | 0.1 | 0.1 | | | 0.1 | 0.1 | |
| D/2 | 0.3 | 0.3 | | | 0.3 | 0.3 | | | |
| D/3 | | | | | | | | | |
| D/4 | | | | | | | | | |
| D/5 | 0.2 | 0.2 | 0.2 | 0.2 | 0.2 | 0.2 | 0.2 | 0.2 | |
| D/6 | | | | | | | | | 0.3 |
| VN (Pellets) | 127 | 128 | 125 | 126 | 125 | 124 | 123 | 123 | 90 |
| [ml/g] | | | | | | | | | |
| Flow spiral | 25 | 18 | 28 | 16.5 | 26 | 19 | 28.5 | 18 | 33.5 |
| [cm] | | | | | | | | | |
| Impact | 25.3 | 27.9 | 20.5 | 22.1 | 23.4 | 26.5 | 18.1 | 20.6 | 23.9 |
| resistance | | | | | | | | | |
| (1 eU) | | | | | | | | | |
| [kJ/m²] | | | | | | | | | |
| Modulus of | 6580 | 8210 | 6430 | 8080 | 7020 | 8740 | 6940 | 8690 | 6720 |
| elasticity | | | | | | | | | |
| [MPa] | | | | | | | | | |
| Tensile | 47/45 | 49/47 | 41/39 | 46/45 | −82 | −83 | −65 | −/82 | 51/50 |
| stress | | | | | | | | | |
| (δ_{y} /δ_{b}) | | | | | | | | | |
| [MPa] | | | | | | | | | |
| Tensile strain | 2.9/5.1 | 2.8/5.1 | 2.7/4.9 | 2.8/5.0 | −/1.4 | −/1.3 | −/1.2 | −/1.4 | 2.5/4.3 |
| (ε_{y} /ε_{b}) | | | | | | | | | |
| [%] | | | | | | | | | |
| Thermal conductivity | 0.91 | 0.93 | 0.78 | 0.99 | 0.92 | 0.93 | 0.78 | 1.00 | 0.94 |
| [W/mK]*⁾ | | | | | | | | | |
| Surface | ∘ | − | ++ | ∘ | ∘ | − | + | ∘ | + |
| quality | | | | | | | | | |

| Components | | | | | | | |
|---|---|---|---|---|---|---|---|
| [% by wt.] | CE 2 | IE3 | CE 3 | CE 4 | CE 5 | CE 6 | CE7**⁾ |
| A/1 | 24.4 | 21.7 | 22.4 | 41 | 69.5 | 24.5 | 14.6 |
| A/2 | 20 | 20 | 20 | | | | |
| B/1 | 55 | 55 | 55 | 55 | 30 | 75 | 85 |
| B/2 | | | | | | | |
| B/3 | | | | | | | |
| B/4 | | | | | | | |
| C | | 0.7 | | | | | |
| D/1 | | | | | | | |
| D/2 | | 0.3 | 0.3 | 0.3 | 0.3 | 0.3 | 0.3 |
| D/3 | | 2 | 2 | 2 | | | |
| D/4 | | | | 1.5 | | | |
| D/5 | | | | 0.2 | 0.2 | 0.2 | 0.2 |
| D/6 | 0.3 | 0.3 | 0.3 | | | | |
| VN (Pellets) | 88 | 92 | 90 | 128 | 127 | 122 | |
| [ml/g] | | | | | | | |
| Flow spiral | 35 | 32 | 33 | 24 | 45 | 11 | |
| [cm] | | | | | | | |
| Impact | 21.7 | 32.8 | 31.6 | 25.6 | 43.2 | 13.3 | |
| resistance | | | | | | | |
| (1 eU) | | | | | | | |
| [kJ/m²] | | | | | | | |
| Modulus of | 7180 | 5810 | 6380 | 5640 | 4480 | 14 210 | |
| elasticity | | | | | | | |
| [MPa] | | | | | | | |
| Tensile | −/84 | 42/41 | 60/59 | 50/47 | 83/81 | −/82 | |
| stress | | | | | | | |
| (δ_{y} /δ_{b}) | | | | | | | |
| [MPa] | | | | | | | |
| Tensile strain | −/1.3 | 2.7/4.5 | 1.9/2.1 | 2.5/3.1 | 6.5/7.2 | −/0.8 | |
| (ε_{y} /ε_{b}) | | | | | | | |
| [%] | | | | | | | |
| Thermal conductivity | 0.93 | 0.93 | 0.94 | 0.94 | 0.50 | 2.17 | |
| [W/mK]*⁾ | | | | | | | |
| Surface | + | + | + | ∘ | + | − | |
| quality | | | | | | | |

δ_{y} = yield stress,
δ_{b} tensile stress at break
ε_{y} = elongation,
ε_{b} = tensile strain at break
*⁾thermal conductivity at 25° C.
**⁾excessive amount of Al oxide, compounded material not capable of further processing because of break-offs of extrudate at extruder die

1. A thermoplastic molding composition, comprising
A) from 19.9 to 59.9% by weight of a thermoplastic polyamide
B) from 40 to 80% by weight of an aluminum oxide or magnesium oxide or a mixture of these
C) from 0.1 to 2% by weight of nigrosin
D) from 0 to 20% by weight of other additives,
where the total of the percentages by weight of A) to D) is 100%.

2. The thermoplastic molding composition according to claim 1, comprising, as component D), at least one stabilizer selected from the group of the cupriferous stabilizers or sterically hindered phenols or amine stabilizers and mixtures of these.

3. The thermoplastic molding composition according to claim 1, where the aspect ratio of component B) is smaller than 10.

4. The thermoplastic molding composition according to claim 1, where the BET surface area to DIN 66131 of component B) is smaller than or equal to 14 m²/g.

5. The thermoplastic molding composition according to claim 1, where the average particle diameter (d₅₀) (according to laser granulometry to ISO 13320 EN) of component B) is from 0.2 to 20 μm.

6. The thermoplastic molding composition according to claim 1, in which the viscosity number (VN) of component A) is from 70 to 170 ml/g (to ISO 307).

7. The thermoplastic molding composition according to claim 1, in which, as further component D), a lubricant selected from the group of the Al or alkali metal or alkaline earth metal salts or esters or amides of fatty acids having from 10 to 44 carbon atoms, or a mixture of these, is used.

8. The thermoplastic molding composition according to claim 1, in which the cupriferous stabilizer is a Cu halide.

9. The thermoplastic molding composition according to claim 1, in which the cupriferous stabilizer is CuI in combination with KI, the amount of KI present here being a 4-fold molar excess, based on CuI.

10. The method of producing fibers, foils or moldings of any type comprising preparing the thermoplastic molding composition according to claim 1.

11. A fiber, a foil, or a molding of any type obtainable from the thermoplastic molding compositions according to claim 1.

12. The thermoplastic molding composition according to claim 2, where the aspect ratio of component B) is smaller than 10.

13. The thermoplastic molding composition according to claim 2, where the BET surface area to DIN 66131 of component B) is smaller than or equal to 14 m²/g.

14. The thermoplastic molding composition according to claim 3, where the BET surface area to DIN 66131 of component B) is smaller than or equal to 14 m²/g.

15. The thermoplastic molding composition according to claim 2, where the average particle diameter (d₅₀) (according to laser granulometry to ISO 13320 EN) of component B) is from 0.2 to 20 μm.

16. The thermoplastic molding composition according to claim 3, where the average particle diameter (d₅₀) (according to laser granulometry to ISO 13320 EN) of component B) is from 0.2 to 20 μm.

17. The thermoplastic molding composition according to claim 4, where the average particle diameter (d₅₀) (according to laser granulometry to ISO 13320 EN) of component B) is from 0.2 to 20 μm.

18. The thermoplastic molding composition according to claim 2, in which the viscosity number (VN) of component A) is from 70 to 170 ml/g (to ISO 307).

19. The thermoplastic molding composition according to claim 3, in which the viscosity number (VN) of component A) is from 70 to 170 ml/g (to ISO 307).

20. The thermoplastic molding composition according to claim 4, in which the viscosity number (VN) of component A) is from 70 to 170 ml/g (to ISO 307).
